(19) United States
(12) Patent Application Publication
(10) Pub. No.: US 2023/0243537 A1
(43) Pub. Date: Aug. 3, 2023

(54) MAINTENANCE MANAGEMENT SYSTEM, MAINTENANCE ASSIST APPARATUS, AND MAINTENANCE MANAGEMENT METHOD

(71) Applicant: Mitsubishi Electric Corporation, Tokyo (JP)

(72) Inventor: Takashi MATSUMOTO, Tokyo (JP)

(21) Appl. No.: 18/003,216

(22) PCT Filed: Sep. 5, 2020
(86) PCT No.: PCT/JP2020/033701

§ 371 Date: Dec. 23, 2022

(51) Int. Cl. F24F 11/39; G06Q 10/20

(52) U.S. Cl. CPC F24F 11/39; G06Q 10/20; F24F 2140/00

(57) ABSTRACT

An image registration unit of a maintenance assist apparatus registers in cleaning service information where usage status of a cleaning service on an air conditioning machine is set, a filter image obtained by a maintenance person photographing a filter of the air conditioning machine. A registration confirmation unit determines whether or not the filter image has been registered in the cleaning service information, when a completion report which reports completion of the cleaning service is received from the maintenance person, outputs to a maintenance terminal apparatus, a completion confirmation notification which notifies that the completion of the cleaning service has been confirmed, when it is determined that the filter image has been registered, and outputs to the maintenance terminal apparatus, a registration warning notification which prompts registration of the filter image, when it is determined that the filter image has not been registered.

### TECHNICAL FIELD

The present disclosure relates to a maintenance management system, a maintenance assist apparatus, a maintenance management method, and a maintenance management program.

### BACKGROUND ART

In recent years, a demand has become higher for an air conditioning machine which performs air conditioning control optimized according to a lifestyle of a user. Further, a service optimized according to the lifestyle of the user is desired to be delivered also in a cleaning service on the air conditioning machine.

The cleaning service on the air conditioning machine is preferably realized based on a coalition of a cleaning provider, a maker of the air conditioning machine, and the user of the air conditioning machine.

Paten Literature 1 discloses creating a dirt severeness diagnosis table and diagnosing dirt severeness in a machine based on a comparison between the dirt severeness diagnosis table and visual inspection by a worker, or a picture.

### CITATION LIST

### Patent Literature

Patent Literature 1: JP2010-054181A

### SUMMARY OF INVENTION

### Technical Problem

Nowadays, the air conditioning machine has been a daily necessity due to weather such as intense heat in the summer. Air conditioning machines are required by the users to be kept clean and comfortable. For this reason, in a cleaning service for a filter, in order to deliver the service optimized according to the lifestyle of the user, adequate accumulation of and a highly accurate analysis on dirt information on the filter have been required.

Patent Literature 1 has a problem that the accumulation of the dirt information and the analysis on the dirt information are inadequate.

A maintenance management system according to the present disclosure aims to certainly accumulate filter images used for performing a highly accurate analysis on dirt on a filter.

### Solution to Problem

A maintenance management system according to the present disclosure, which manages maintenance of an air conditioning machine, including:

a maintenance assist apparatus which assists with the maintenance of the air conditioning machine; and

a maintenance terminal apparatus carried by a maintenance person who implements a cleaning service on the air conditioning machine, wherein

the maintenance assist apparatus includes:

an image registration unit to register in cleaning service information where usage status of the cleaning service on the air conditioning machine is set, a filter image obtained by the maintenance person photographing a filter of the air conditioning machine; and

a registration confirmation unit to determine whether or not the filter image has been registered in the cleaning service information, when a completion report which reports completion of the cleaning service is received from the maintenance person, output to the maintenance terminal apparatus, a completion confirmation notification which notifies that the completion of the cleaning service has been confirmed, when it is determined that the filter image has been registered, and output to the maintenance terminal apparatus, a registration warning notification which prompts registration of the filter image, when it is determined that the filter image has not been registered.

### Advantageous Effects of Invention

According to a maintenance management system according to the present disclosure, it is possible to certainly accumulate filter images used for performing a highly accurate analysis on dirt on a filter.

### BRIEF DESCRIPTION OF DRAWINGS

FIG. 1 is a configuration example of a maintenance management system according to a first embodiment;

FIG. 2 is a refrigerant circuit at a time of a cooling operation of an air conditioning machine according to the first embodiment.

FIG. 3 is a refrigerant circuit at a time of a heating operation of the air conditioning machine according to the first embodiment.

FIG. 4 is a configuration diagram of a management apparatus according to the first embodiment.

FIG. 5 is a configuration diagram of a maintenance assist apparatus according to the first embodiment.

FIG. 6 is a configuration diagram of an air conditioning machine according to the first embodiment.

FIG. 7 is a configuration diagram of control equipment according to the first embodiment.

FIG. 8 is a configuration diagram of a maintenance terminal apparatus according to the first embodiment.

FIG. 9 is a flow diagram illustrating an operation example of the maintenance terminal apparatus according to the first embodiment.

FIG. 10 is a schematic diagram illustrating an example of photographing of a filter by the maintenance terminal apparatus according to the first embodiment.

FIG. 11 is a schematic diagram illustrating an example of photographing of the filter by the maintenance terminal apparatus according to the first embodiment.

FIG. 12 is a diagram illustrating an example of lifestyle information according to the first embodiment.

FIG. 13 is a flow diagram illustrating an operation example of the maintenance assist apparatus according to the first embodiment.

FIG. 14 is a configuration diagram of a maintenance assist apparatus according to a modification example of the first embodiment.

FIG. 15 is a configuration example of a maintenance management system according to a second embodiment.

FIG. 16 is a configuration diagram of a maintenance assist apparatus according to the second embodiment.

FIG. 17 is a configuration diagram of control equipment according to the second embodiment.

FIG. 18 is a flow diagram illustrating an operation example of a maintenance terminal apparatus according to the second embodiment.

FIG. 19 is a flow diagram illustrating an operation example of the control equipment according to the second embodiment.

FIG. 20 is a diagram illustrating an example of lifestyle information according to the second embodiment.

### DESCRIPTION OF EMBODIMENTS

Below, the present embodiments will be described with reference to the drawings. In each drawing, the same or corresponding parts are denoted by the same reference signs. In the description of the embodiments, description of the same or corresponding parts will be suitably omitted or simplified. Further, in the drawings hereinafter, the relative sizes of components may be different from actual ones. Further, in the description of the embodiments, directions or positions such as “up”, “down”, “left”, “right”, “front”, “rear”, “top side”, and “back side” may be indicated. These terms are described for convenience of description, and are not intended to limit the placement, orientation, and direction of apparatuses, tools, portions, or the like.

### First Embodiment

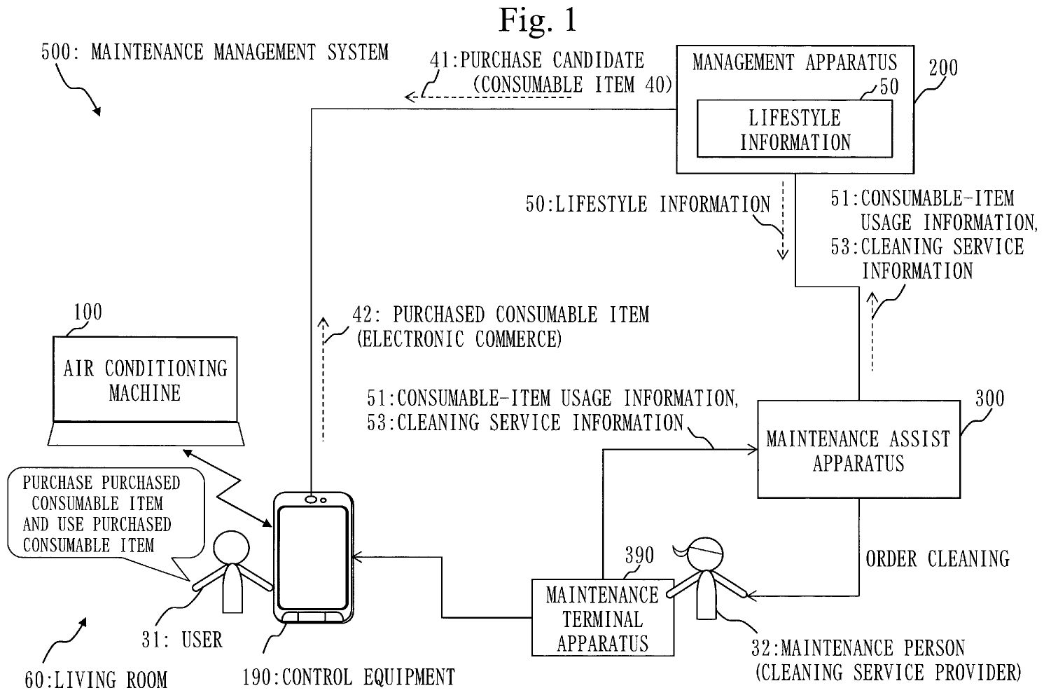

A configuration of the present embodiment will be described with reference to FIGS. 1 to 6.

***Description of Configuration***

FIG. 1 is a diagram illustrating a configuration example of a maintenance management system 500 according to the present embodiment.

The maintenance management system 500 manages maintenance of an air conditioning machine 100. The maintenance management system 500 is a system which realizes a platform for an air-conditioning-machine total service which connects with each other, control, equipment 190 used by a user 31, a management apparatus 200 used by a maker, and a maintenance assist apparatus 300 used by a maintenance assist provider. The maintenance management system 500 includes the management apparatus 200 which manages the air conditioning machine 100 controlled by the control equipment 190, and the maintenance assist apparatus 300 which assists with the maintenance of the air conditioning machine 100.

The air conditioning machine 100 is installed in a living room 60 where the user 31 lives a daily life. The air conditioning machine 100 is a refrigeration cycle apparatus which realizes functions such as cooling and heating.

The air conditioning machine 100 communicates with the control equipment 190 via a wireless LAN (Local Area Network) such as Wi-Fi (registered trademark), or near-field communication such as Bluetooth (registered trademark). Further, the air conditioning machine 100 communicates with the management apparatus 200 via a network such as the Internet.

The management apparatus 200 may be a cloud server installed in a cloud system. The management apparatus 200 is specifically a server managed by a maker of the air conditioning machine 100.

The maintenance assist apparatus 300 is a server managed by a company which delivers a maintenance service, such as a cleaning provider. The maintenance assist apparatus 300 is connected, via the network, to a maintenance terminal apparatus 390 carried by a maintenance person 32 who is a worker performs the maintenance service such as cleaning.

The maintenance terminal apparatus 390 is specifically a smartphone terminal, a tablet terminal, or a computer terminal such as a PC (Personal Computer).

The control equipment 190 is equipment utilized by the user 31 to control the air conditioning machine 100. The control equipment 190 is connected to the management apparatus 200 via the network. Otherwise, the control equipment 190 may be connected to the maintenance assist apparatus 300 via the network. Further, the control equipment 190 and the maintenance terminal apparatus 390 can communicate with each other via the network or the near-field communication.

The control equipment 190 is specifically a smartphone terminal, a tablet terminal, or a computer terminal such as a PC. Further, the control equipment 190 may be a computer terminal dedicated to the air conditioning machine 100.

The air conditioning machine 100 includes a sensor unit and a control program which are not illustrated. The control program is a program used for controlling operation performance of the air conditioning machine 100. The control program is specifically such a program that controls the air conditioning machine by operation performance of 2.2 kW.

The sensor unit senses states of the living room 60. The states of the living room 60 are specifically states of the living room 60 such as: a room shape; an indoor heat load such as high thermal isolation or low thermal isolation; furniture arrangement; a living area of the user; or a flow line of the user. These states of the living room 60 are set in lifestyle information 50 of the management apparatus 200 in real time as living-room information. The sensor unit is specifically an infrared sensor which detects indoor absolute temperature. Further, the sensor unit may include equipment such as a camera which photographs the inside of the room. Further, the sensor unit senses an air-flow-reaching limit range in the living room 60 by using the sensor which enables sensing an air-flow-reaching degree of the air conditioning machine 100 in real time. Then, a current air-flow-reaching limit range in the living room 60 is set in the living-room information.

The air conditioning machine 100 includes a sensor unit which detects temperature of the living room 60 while rotating. For example, the sensor unit creates one thermographic image, for example, by rotating 360 degrees in a horizontal direction. Then, the states of the inside of the room, such as a living area of the user in the living room 60 and the indoor temperature are detected by obtaining a difference between the thermal image created by a rotation of the sensor unit and the thermal image created by the previous rotation.

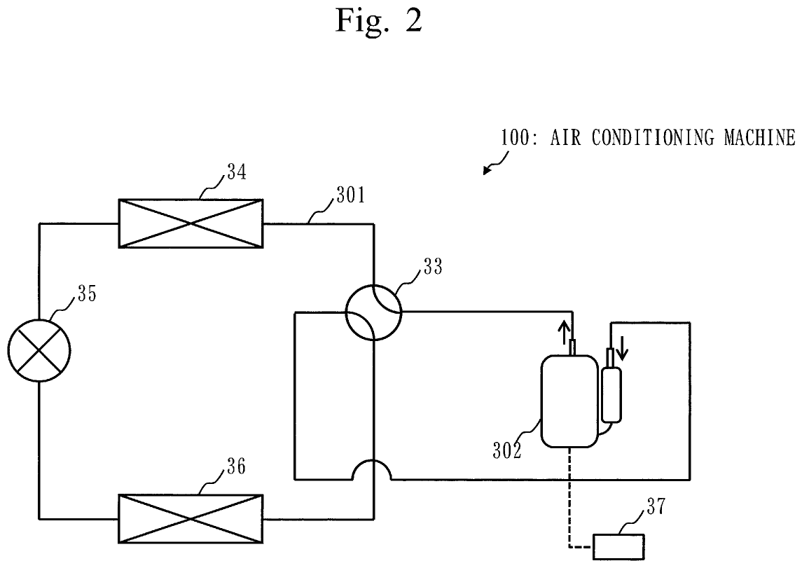

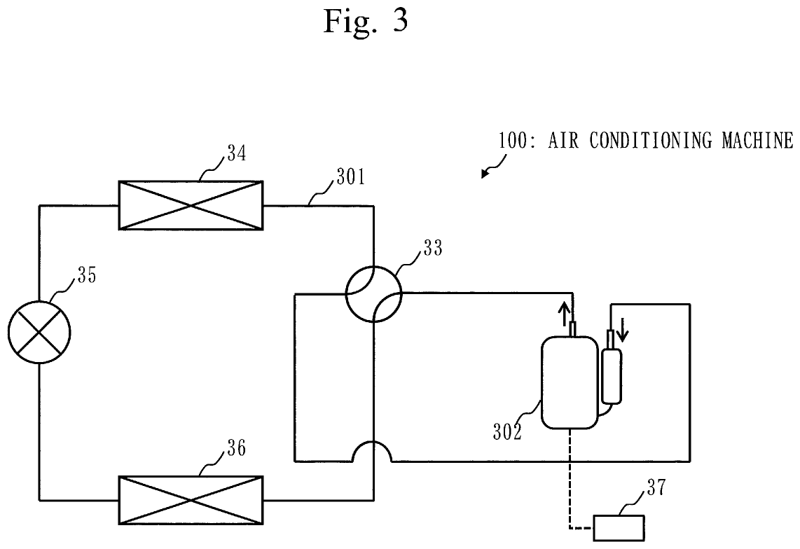

With reference to FIGS. 2 and 3, configurations of the air conditioning machine 100 will be described.

FIG. 2 illustrates a refrigerant circuit 301 at a time of a cooling operation. FIG. 3 illustrates the refrigerant circuit 301 at a time of a heating operation.

The air conditioning machine 100 includes the refrigerant circuit 301 where the refrigerant circulates. The air conditioning machine 100 further includes: a compressor 302; a four-way valve 33; a first heat exchanger 34 which is an outdoor-heat exchanger; an expansion mechanism 35 which is an expansion valve; and a second heat exchanger 36 which is an indoor-heat exchanger. The compressor 302, the four-way valve 33, the first heat exchanger 34, the expansion mechanism 35, and the second heat exchanger 36 are connected to the refrigerant circuit 301.

The compressor 302 compresses the refrigerant. The four-way valve 33 switches directions in which the refrigerant flows, depending on whether it is a time of the cooling operation or a time of the heating operation. The first heat exchanger 34 operates as a condenser at the time of the cooling operation and radiates heat of the refrigerant compressed by the compressor 302. That is, the first heat exchanger 34 exchanges the heat, using the refrigerant compressed by the compressor 302. The first heat exchanger 34 operates as an evaporator at the time of the heating operation, and heats the refrigerator, by exchanging the heat between outdoor air and the refrigerator expanded by the expansion mechanism 35. The expansion mechanism 35 expands the refrigerator whose heat has been radiated by the condenser. The second heat exchanger 36 operates as the condenser at the time of the heating operation, and radiates the heat of the refrigerator compressed by the compressor 302. That is, the second heat exchanger 36 exchanges the heat, using the refrigerant compressed by the compressor 302. The second heat exchanger 36 operates as the evaporator at the time of the cooling operation, and heats the refrigerator, by exchanging the heat between the indoor air and the refrigerant expanded by the expansion mechanism 35.

The air conditioning machine 100 further includes a controller 37 which controls a refrigeration cycle of the air conditioning machine 100. The controller 37 controls the refrigeration cycle of the air conditioning machine 100 by executing the control program.

FIGS. 2 and 3 illustrate only connection between the controller 37 and the compressor 302, however, the controller 37 may be connected to not only the compressor 302 but also components other than the compressor 302 connected to the refrigerant circuit 301. The controller 37 monitors and controls a state of each component connected to the controller 37.

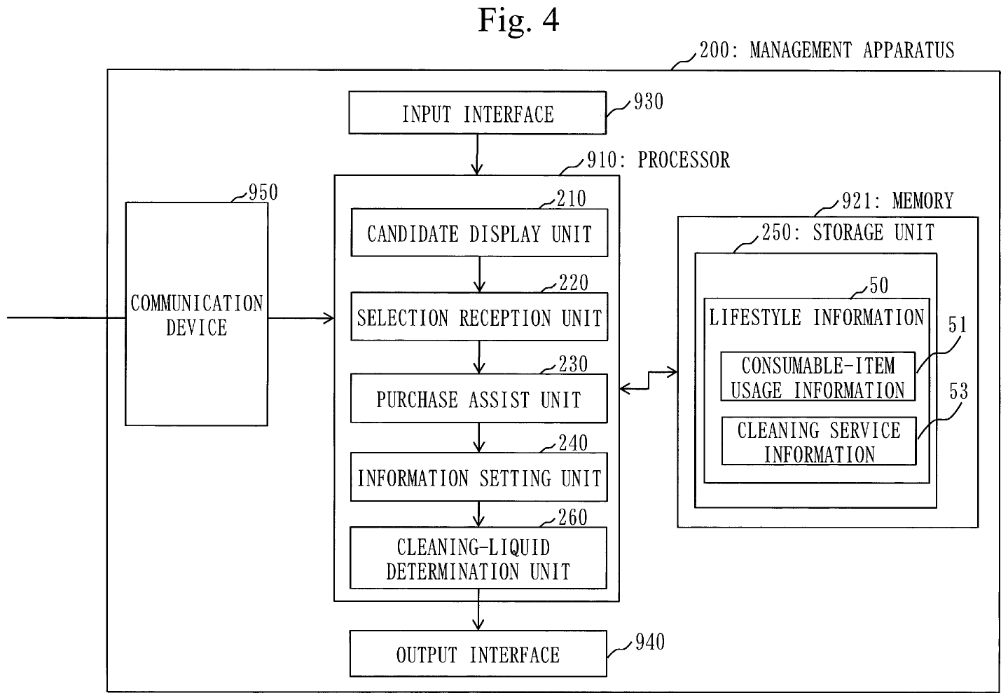

FIG. 4 is a diagram illustrating a configuration of the management apparatus 200 according to the present embodiment.

The management apparatus 200 is a computer. The management apparatus 200 includes a processor 910, and also includes other pieces of hardware such as a memory 921, an input interface 930, an output interface 940, and a communication device 950. The processor 910 is connected to the other pieces of hardware via a signal line, and controls these other pieces of hardware. Further, the management apparatus 200 includes an auxiliary storage device which is not illustrated.

The management apparatus 200 includes a candidate display unit 210, a selection reception unit 220, a purchase assist unit 230, an information setting unit 240, a cleaning-liquid determination unit 260, and a storage unit 250 as functional elements.

Functions of the candidate display unit 210, the selection reception unit 220, the purchase assist unit 230, the information setting unit 240, and the cleaning-liquid determination unit 260 are realized by software. The storage unit 250 is included in the memory 921. The storage unit 250 stores the lifestyle information 50.

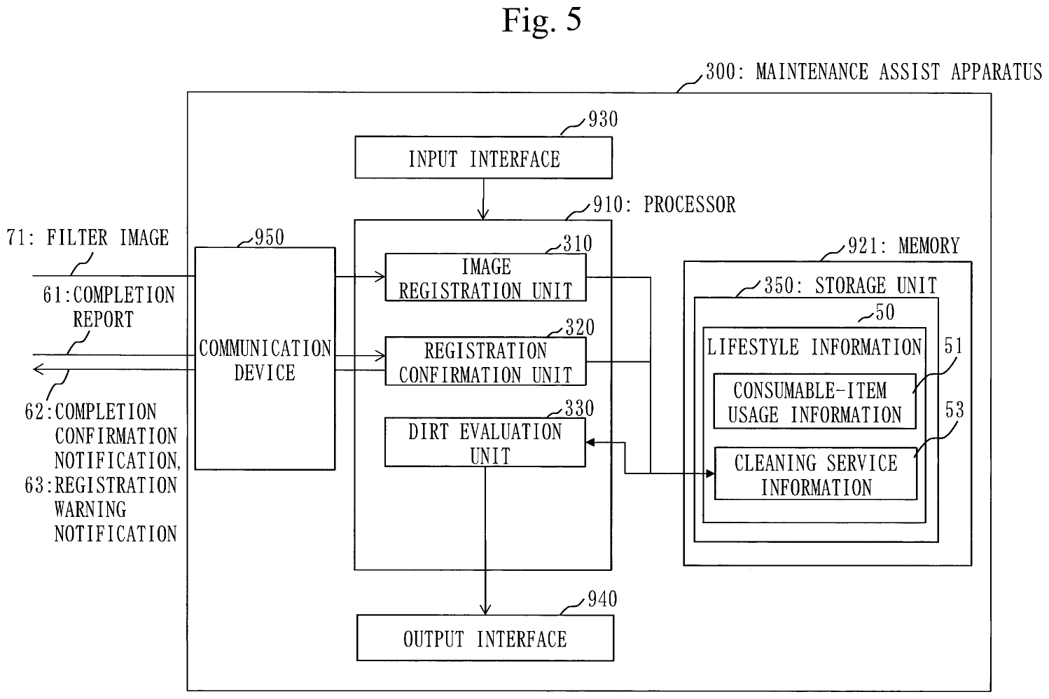

FIG. 5 is a diagram illustrating a configuration of the maintenance assist apparatus 300 according to the present embodiment.

The maintenance assist apparatus 300 is a computer. The maintenance assist apparatus 300 includes the processor 910, and also includes other pieces of hardware such as the memory 921, the input interface 930, the output interface 940, and the communication device 950. The processor 910 is connected to the other pieces of hardware via the signal line, and controls these other pieces of hardware. Further, the maintenance assist apparatus 300 includes an auxiliary storage device which is not illustrated.

The maintenance assist apparatus 300 includes an image registration unit 310, a registration confirmation unit 320, a dirt evaluation unit 330, and a storage unit 350 as functional elements.

Functions of the image registration unit 310, the registration confirmation unit 320, and the dirt evaluation unit 330 are realized by the software. The storage unit 350 is included in the memory 921. The storage unit 350 stores the lifestyle information 50.

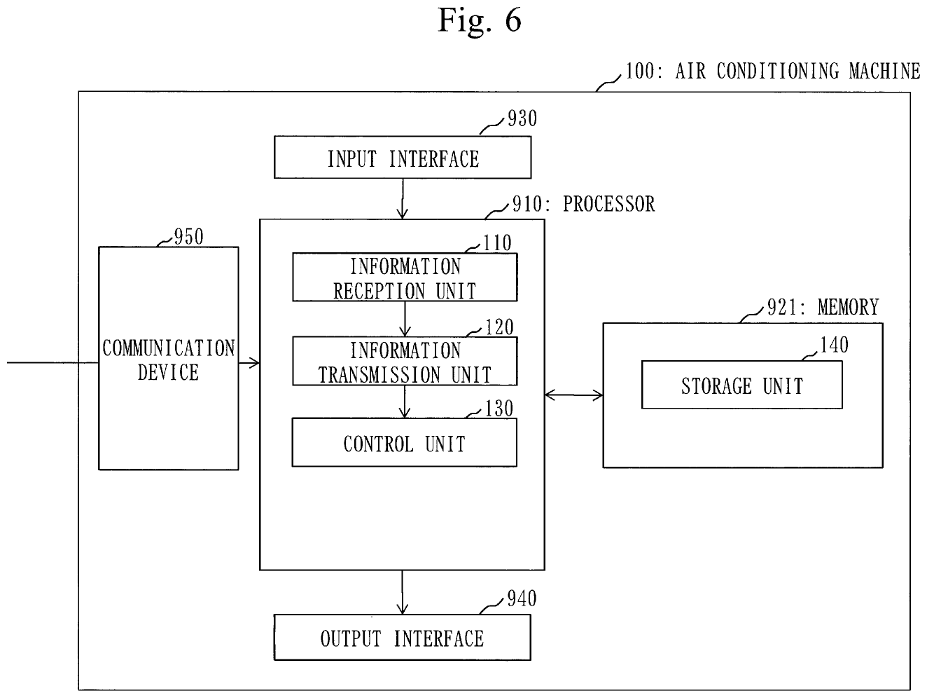

FIG. 6 is a diagram illustrating a configuration of the air conditioning machine 100 according to the present embodiment.

The air conditioning machine 100 includes a computer. The air conditioning machine 100 includes the processor 910, and also includes other pieces of hardware such as the memory 921, the input interface 930, the output interface 940, and the communication device 950. The processor 910 is connected to the other pieces of hardware via the signal line, and controls these other pieces of hardware. Further, the air conditioning machine 100 includes an auxiliary storage device which is not illustrated.

The air conditioning machine 100 includes an information reception unit 110, an information transmission unit 120, a control unit 130, and a storage unit 140 as functional elements.

Functions of the information reception unit 110, the information transmission unit 120, and the control unit 130 are realized by the software. The storage unit 140 is included in the memory 921. The storage unit 140 stores the lifestyle information 50. Further, the control unit 130 is the example of the controller 37 in FIGS. 2 and 3.

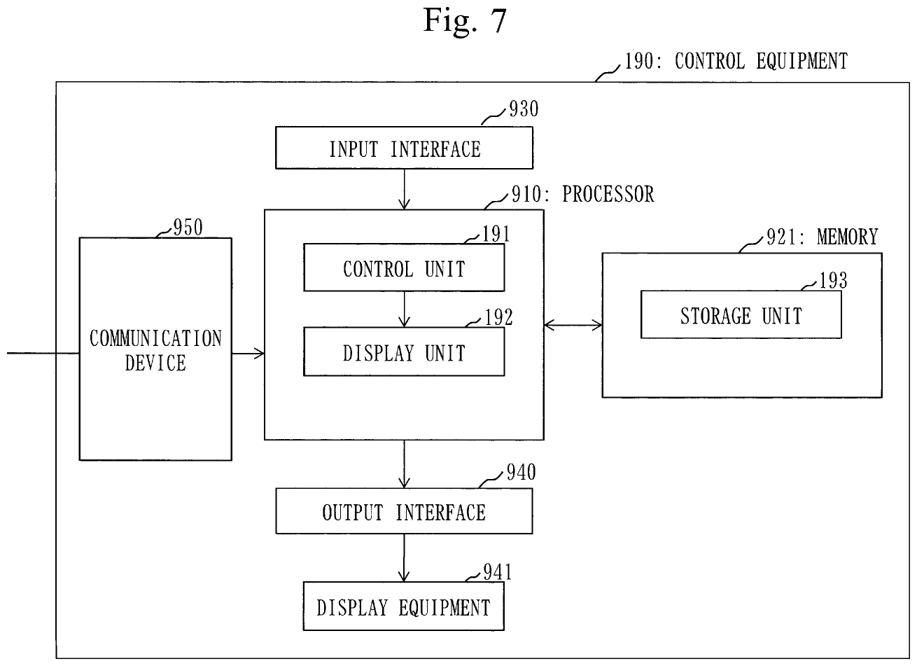

FIG. 7 is a diagram illustrating a configuration of the control equipment 190 according to the present embodiment.

The control equipment 190 is a computer. The control equipment 190 includes the processor 910, and also includes other pieces of hardware such as the memory 921, the input interface 930, the output interface 940, and the communication device 950. The processor 910 is connected to the other pieces of hardware via the signal line, and controls these other pieces of hardware. Further, the control equipment 190 includes the auxiliary storage device which is not illustrated. Further, display equipment 941 such as a display is connected to the output interface 940.

The control equipment 190 includes a control unit 191, a display unit 192, and a storage unit 193 as functional elements.

Functions of the control unit 191 and the display unit 192 are realized by the software. The storage unit 193 is included in the memory 921.

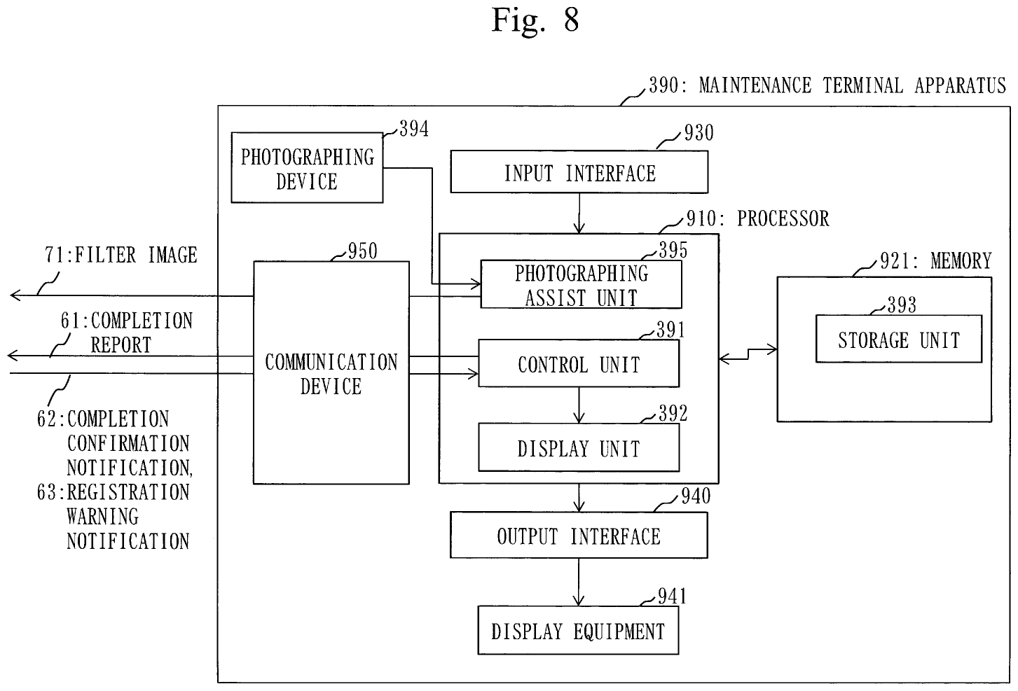

FIG. 8 is a diagram illustrating a configuration of the maintenance terminal apparatus 390 according to the present embodiment.

The maintenance terminal apparatus 390 is a computer. The maintenance terminal apparatus 390 includes the processor 910, and also includes other pieces of hardware such as the memory 921, the input interface 930, the output interface 940, a photographing device 394, and the communication device 950. The processor 910 is connected to the other pieces of hardware via the signal line, and controls these other pieces of hardware. Further, the maintenance terminal apparatus 390 includes the auxiliary storage device which is not illustrated. Further, the display equipment 941 such as a display is connected to the output interface 940.

The maintenance terminal apparatus 390 includes a photographing assist unit 395, a control unit 391, a display unit 392, and a storage unit 393 as functional elements.

Functions of the photographing assist unit 395, the control unit 391, and the display unit 392 are realized by the software. The storage unit 393 is included in the memory 921. For example, the photographing device 394 is a built-in camera in the smartphone or the tablet terminal each of which is the maintenance terminal apparatus 390.

Note that, in the present embodiment, in order to simplify descriptions, the same reference numerals are assigned to pieces of hardware which have the same functions. However, each of the air conditioning machine 100, the management apparatus 200, the maintenance assist apparatus 300, the control equipment 190, and the maintenance terminal apparatus 390 has individual pieces of hardware.

The processor 910 is a device which executes a maintenance management program. The maintenance management program is a program which realizes functions of the air conditioning machine 100, the management apparatus 200, the maintenance assist apparatus 300, the control equipment 190, or the maintenance terminal apparatus 390. The functions of the air conditioning machine 100 are the functions of the information reception unit 110, the information transmission unit 120, and the control unit 130. The functions of the management apparatus 200 are the functions of the candidate display unit 210, the selection reception unit 220, the purchase assist unit 230, the information setting unit 240, and the cleaning-liquid determination unit 260. The functions of the maintenance assist apparatus 300 are the functions of the image registration unit 310, the registration confirmation unit 320, and the dirt evaluation unit 330. The functions of the control equipment 190 are the functions of the control unit 191 and the display unit 192. The functions of the maintenance terminal apparatus 390 are the functions of the photographing assist unit 395, the control unit 391, and the display unit 392. In below descriptions, at least a part of the air conditioning machine 100, the management apparatus 200, the maintenance assist apparatus 300, the control equipment 190, and the maintenance terminal apparatus 390 is referred to as each apparatus of the maintenance management system 500. Further, at least a part of the functions of the air conditioning machine 100, the management apparatus 200, the maintenance assist apparatus 300, the control equipment 190, or the maintenance terminal apparatus 390 is referred to as a function of each apparatus in the maintenance management system 500.

The processor 910 is an IC (Integrated Circuit) which performs a calculation process. Specific examples of the processor 910 are a CPU (Central Processing Unit), a DSP (Digital Signal Processor), and a GPU (Graphics Processing Unit).

The memory 921 is a storage device which temporally stores data. A specific example of the memory 921 is an SRAM (Static Random Access Memory) or a DRAM (Dynamic Random Access Memory).

The auxiliary storage device is a storage device which stores data. A specific example of the auxiliary storage device is an HDD. Further, the auxiliary storage device may be a portable storage medium such as an SD (registered trademark) memory card, a CF, a NAND flash, a flexible disk, an optical disc, a compact disc, a Blue-ray (registered trademark) disc, or a DVD. Note that, HDD stands for Hard Disk Drive. SD (registered trademark) stands for Secure Digital. CF stands for CompactFlash (registered trademark). DVD stands for Digital Versatile Disk.

The input interface 930 is a port to be connected to a mouse, a keyboard, or an input device such as a touch panel. The input interface 930 is specifically a USB (Universal Serial Bus) terminal. Note that, the input interface 930 may be a port to be connected to a LAN (Local Area Network).

The output interface 940 is a port to which a cable of output equipment such as a display is to be connected. The output interface 940 is specifically a USB terminal or an HDMI (registered trademark) (High Definition Multimedia Interface) terminal. The display is specifically an LCD (Liquid Crystal Display).

The communication device 950 has a receiver and a transmitter. The communication device 950 is connected to a communication network such as a LAN, the Internet, or a telephone line. The communication device 950 is specifically a communication chip or an NIC (Network Interface Card).

The maintenance management system is executed in each apparatus in the maintenance management system 500. The maintenance management system is read into the processor 910 and executed by the processor 910. The memory 921 stores not only the maintenance management system but also an OS (Operating System). While executing the OS, the processor 910 executes the maintenance management system. The maintenance management system and the OS may be stored in the auxiliary storage device. The maintenance management system and the OS which are stored in the auxiliary storage device are loaded into the memory 921 and executed by the processor 910. Note that, a part or all of the maintenance management system may be incorporated into the OS.

Each apparatus in the maintenance management system 500 may include a plurality of processors which substitute the processor 910. This plurality of processors share execution of the maintenance management system. Each processor is a device which executes the maintenance management system as with the processor 910.

Data, information, a signal value, and a variable value utilized, processed, or output by the maintenance management system are stored in the memory 921, the auxiliary storage device, or a register or a cash memory in the processor 910.

“Unit” of each unit of each apparatus in the maintenance management system 500 may be read as “process”, “procedure”, or “step”. Further, “process” as which “unit” of each unit of each apparatus in the maintenance management system 500 is read may be read as “program” or “program product”. Further, “process” as which “unit” of each unit of each apparatus in the maintenance management system 500 is read may be read as “a computer-readable storage medium storing a program” or “a computer-readable recording medium recording a program”.

The maintenance management system causes the computer to execute each process, each procedure, or each step obtained by reading “unit” of each unit as “process”, “procedure”, or “step”. Further, a maintenance management method is a method implemented by each apparatus in the maintenance management system 500, executing the maintenance management system.

The maintenance management system may be stored in the computer readable recording medium or storage medium, and provided. Further, the maintenance management system may be provided as a program product.

***Description of Operation***

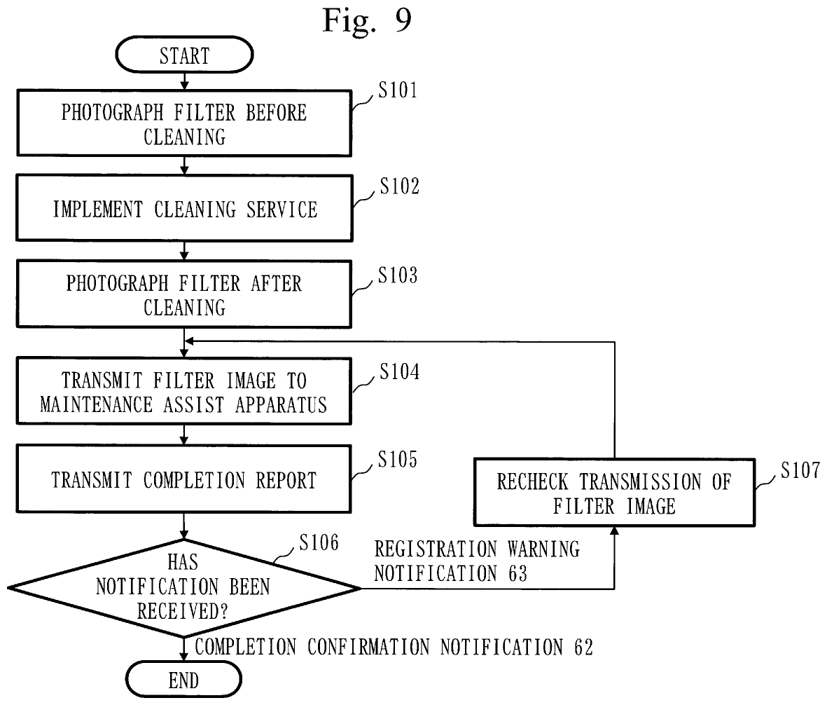

With use of FIGS. 9 to 13, operations of the maintenance management system 500 according to the present embodiment will be described.

An operation procedure of the maintenance management system 500 is equivalent to the maintenance management method. Further, a program which realizes the operations of the maintenance management system 500 is equivalent to the maintenance management program.

The maintenance management system 500 includes the maintenance assist apparatus 300 which assists with the maintenance of the air conditioning machine 100, and the maintenance terminal apparatus 390 carried by the maintenance person 32 who implements a cleaning service on the air conditioning machine 100. The maintenance management system 500 manages the maintenance of the air conditioning machine 100.

<Operations of Maintenance Terminal Apparatus 390>

FIG. 9 is a flow diagram indicating an operation example of the maintenance terminal apparatus 390 according to the present embodiment.

Here, a process when the maintenance person 32 implements the cleaning service to clean a filter of the air conditioning machine 100 will be described. The maintenance person 32 visits a residence of the user of the air conditioning machine 100, carrying the maintenance terminal apparatus 390. Then, the maintenance person 32 implements the cleaning service and the maintenance service on the air conditioning machine 100 while performing communication with the maintenance assist apparatus 300 via the maintenance terminal apparatus 390. Further, the maintenance person 32 presents to the user of the air conditioning machine 100, pieces of information such as information on inquiry about a product, and information on a consumable item 40 or a maintenance method each of which is optimized for a lifestyle of the user.

In step S101, the photographing device 394 of the maintenance terminal apparatus 390 photographs a filter 101 of the air conditioning machine 100 before the cleaning service is implemented, by the control by the maintenance person 32.

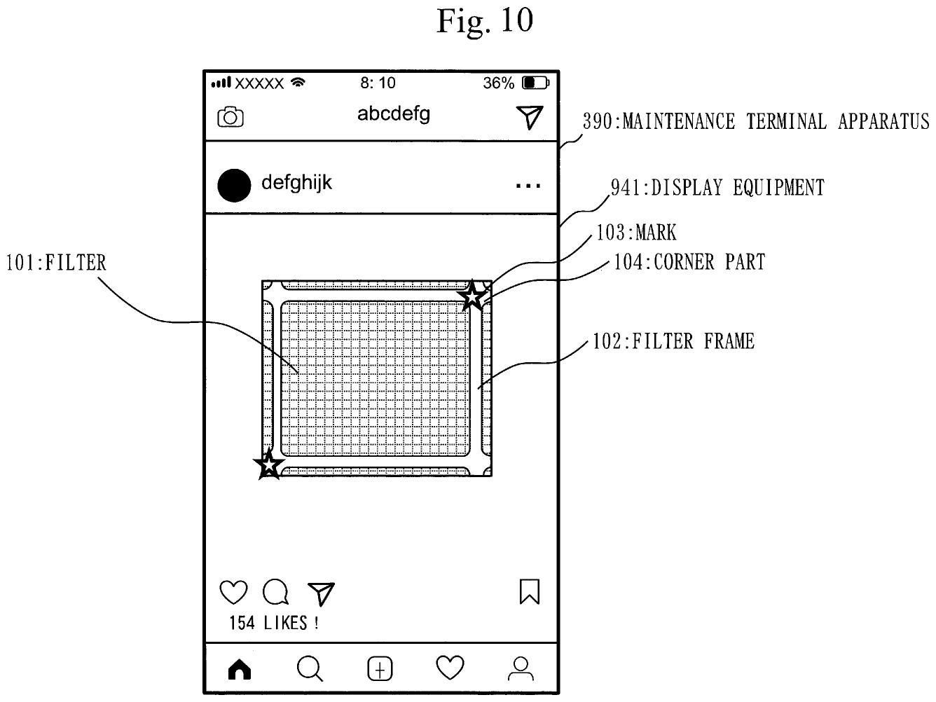

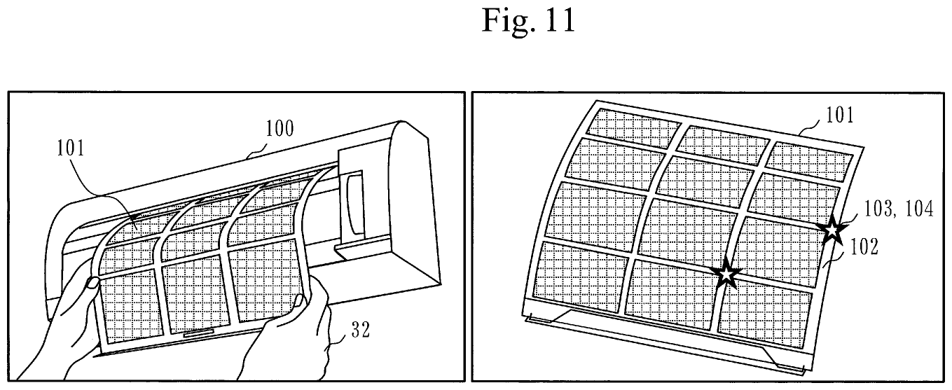

FIGS. 10 and 11 are schematic diagrams illustrating examples of photographing the filter 101 by the maintenance terminal apparatus 390 according to the present embodiment.

The photographing assist unit 395 of the maintenance terminal apparatus 390 assists the photographing device 394 in photographing the filter 101. The photographing assist unit 395 displays on the display equipment 941, specific marks 103 at which a filter frame 102 included in the filter 101 is to be positioned. The photographing device 394 photographs the filter 101, positioning the filter frame 102 included in the filter 101 at the specific marks 103, by the control by the maintenance person 32. For example, the photographing device 394 photographs the filter 101, positioning corner parts 104 of the filter frame 102 included in the filter 101 at the specific marks 103, by the control by the maintenance person 32.

As illustrated in FIGS. 10 and 11, photographing the filter 101 while positioning the filter frame 102 at the specific marks 103 can reduce variance of filter images 71 acquired by the maintenance terminal apparatus 390.

In step S102, the cleaning service is implemented by the maintenance person 32.

In step S103, the photographing device 394 of the maintenance terminal apparatus 390 photographs the filter 101 of the air conditioning machine 100 after the cleaning, by the control by the maintenance person 32.

A photographing method is the same as step S101. As illustrated in FIGS. 10 and 11, the photographing assist unit 395 facilitates photographing the filter 101 by enabling the filter frame 102 included in the filter 101 to be positioned at the specific marks 103. For example, the photographing assist unit 395 facilitates photographing the filter 101 by enabling the corner parts 104 of the filter frame 102 included in the filter 101 to be positioned at the specific marks 103.

In step S104, the photographing assist unit 395 transmits the filter image 71 to the maintenance assist apparatus 300 via the communication device 950. The filter image 71 includes an image of the filter 101 before the cleaning service is implemented, and an image of the filter 101 after the cleaning service is implemented. The display unit 392 displays on the display equipment 941, the image of the filter 101 before the cleaning, and the image of the filter 101 after the cleaning. As a result, the maintenance person 32 can check the filter image 71 displayed on the display equipment 941.

In step S105, when the implementation of the cleaning service is completed, the maintenance person 32 transmits a completion report 61 which reports the completion of the cleaning service, from the maintenance terminal apparatus 390.

In step S106, the control unit 391 determines as to a notification from the maintenance assist apparatus 300, which is a response to the completion report 61. When a completion confirmation notification 62 is received from the maintenance assist apparatus 300, the control unit 391 ends the process. Alternatively, the control unit 391 notifies the maintenance person 32 that the process has been ended. The completion confirmation notification 62 is a notification indicating that the completion of the implementation of the cleaning service has been confirmed.

Further, when a registration warning notification 63 is received from the maintenance assist apparatus 300, the control unit 391 proceeds to step S107. A registration warning notification 63 is a notification to warn that the transmission of the filter image 71 has not been completed.

In step S107, the maintenance terminal apparatus 390 displays on the display equipment 941, the filter image 71 and the transmission record of the filter image 71, and urges the maintenance person 32 to recheck the transmission of the filter image 71. The maintenance person 32 checks the filter image 71 and the transmission record of the filter image 71 which are displayed on the display equipment 941, and rephotographs or retransmits the filter image 71.

<Operations of Maintenance Assist Apparatus 300>

Next, operations of the maintenance assist apparatus 300 according to the present embodiment will be described.

When the maintenance assist apparatus 300 receives the filter image 71 from the maintenance terminal apparatus 390, the maintenance assist apparatus 300 registers the filter image 71 in cleaning service information 53. Specifically, the image registration unit 310 registers in the cleaning service information 53, the filter image 71 obtained by photographing the filter 101 of the air conditioning machine 100. The filter image 71 is an image photographed by the maintenance person 32 who has implemented the cleaning service on the air conditioning machine 100.

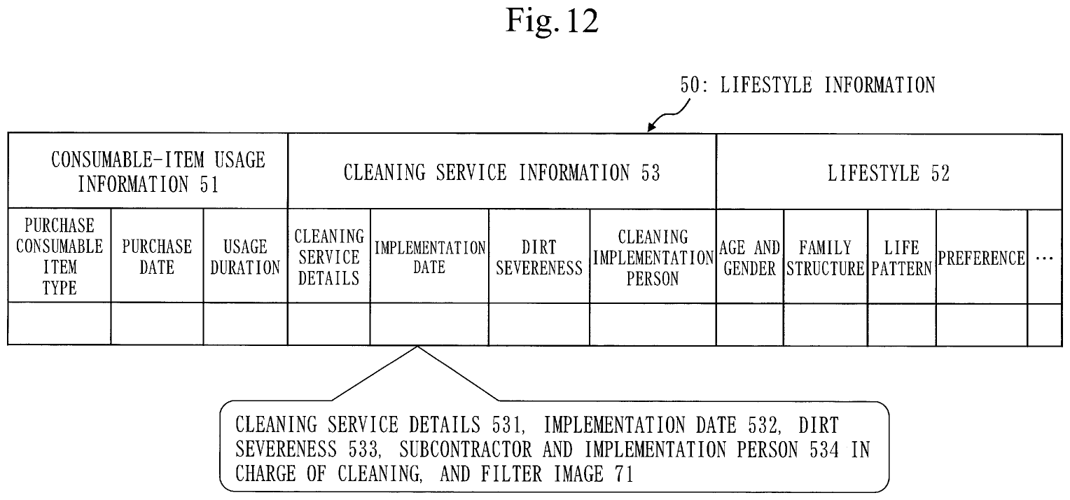

FIG. 12 is a diagram illustrating an example of the lifestyle information 50 according to the present embodiment.

The lifestyle information 50 is information indicating a lifestyle of the user 31. Consumable-item usage information 51, the cleaning service information 53, and a lifestyle 52 of the user 31 are set in the lifestyle information 50. Further, another piece of information such as living-room information regarding the living room 60 of the user 31 may be included.

For example, in the living room information, pieces of information are set, such as: a room shape; a heat load such as high heat insolation or low heat insolation; furniture arrangement; a living area of the user; a flow line of the user; and an air-flow-reaching limit range.

In the lifestyle 52, various types of information for specifying the lifestyle of the user 31 are set. For example, pieces of information on the user 31 are preferably included, such as gender, age, a family structure, a job type, an action pattern, preference, or information on a residential property. Further, pieces of vital data on a human body such as blood pressure, a heart rate, and breath are preferably included. From these lifestyles 52, the lifestyle itself is recognized as an attribute of the user. As a specific example, when the user 31 is in a two-members household which is a male in his thirties and a female in her thirties, it is preferable to recognize whether or not the household is a dual-income household without a child. It is preferable to recognize as the attributes, action patterns such as what time they wake up, leave home, come back home, take shower, and go to bed. It is also preferable to recognize as the attributes, preferences such as being sensitive to heat or being sensitive to cold. Alternatively, preference such prioritizing comfort or prioritizing energy saving may be included. Further, preference of color or a shape of an object may be included.

In the consumable-item usage information 51, information regarding the consumable item 40 purchased by the user 31 is set. For example, in the consumable-item usage information 51, pieces of information on a purchased consumable item 42 are set, such as a type, a purchase date, and a usage period.

Further, in the cleaning service information 53, usage status of the cleaning service on the air conditioning machine 100 is set. In the cleaning service information 53, information regarding implementation history of the cleaning service on the air conditioning machine 100 is set. For example, in the cleaning service information 53, pieces of information are set, such as cleaning service details 531, an implementation date 532, dirt severeness 533, a provider and an implementation person 534 in charge of the cleaning, and the filter image 71.

Note that, in the present embodiment, the cleaning service information 53 is included in the lifestyle information 50 indicating the lifestyle of the user who uses the air conditioning machine 100. However, the cleaning service information 53 may be provided separately from the lifestyle information 50. In that case, the lifestyle information 50 and the cleaning service information 53 need to be associated with each other by information such as an identifier for identifying the user or the air conditioning machine 100.

Further, the lifestyle information 50 of the management apparatus 200 and the lifestyle information 50 of the maintenance assist apparatus 300 are updated with synchronization. For example, in a case that the management apparatus 200 updates the lifestyle information 50, the management apparatus 200 may be configured to transmit the latest lifestyle information 50 to the maintenance assist apparatus 300 right after updating the lifestyle information 50. Alternatively, each of the management apparatus 200 and the maintenance assist apparatus 300 may be configured to transmit the latest lifestyle information 50 to the counterpart right after updating the lifestyle information 50 of its own.

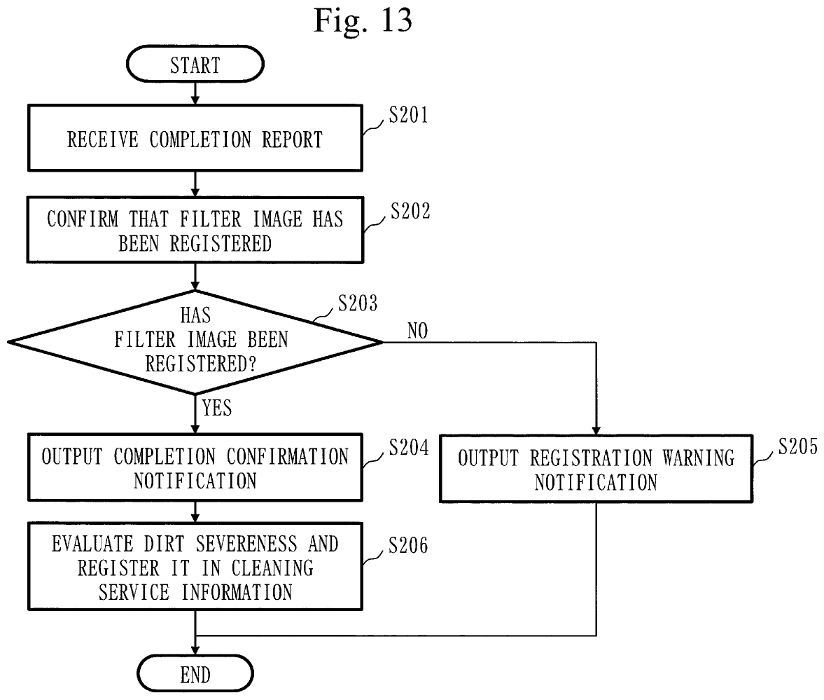

FIG. 13 is a flow diagram indicating an operation example of the maintenance assist apparatus 300 according to the present embodiment.

In step S201, the maintenance assist apparatus 300 receives the completion report 61 from the maintenance terminal apparatus 390.

In step S202, the registration confirmation unit 320 determines whether or not the filter image 71 has been registered in the cleaning service information 53.

In step S203, when it is determined that the filter image 71 has been registered, the process proceeds to step S204. When it is determined that the filter image 71 has not been registered, the process proceeds to step S205.

In step S204, the registration confirmation unit 320 outputs to the maintenance terminal apparatus 390, the completion confirmation notification 62 which notifies that the completion of the cleaning service has been confirmed. Specifically, the registration confirmation unit 320 transmits the completion confirmation notification 62 to the maintenance terminal apparatus 390 via the communication device 950. Then, the process proceeds to step S206.

In step S205, the registration confirmation unit 320 outputs to the maintenance terminal apparatus 390, the registration warning notification 63 which prompts registration of the filter image 71. Specifically, the registration confirmation unit 320 transmits the registration warning notification 63 to the maintenance terminal apparatus 390 via the communication device 950. Then, the process ends.

In step S206, the dirt evaluation unit 330 determines the dirt severeness 533 on the filter 101 based on the filter image 71 registered in the cleaning service information 53, and registers the dirt severeness 533 in the cleaning service information 53. Dirt such as dust is prone to stick to the filter 101. The dirt evaluation unit 330 determines the dirt severeness 533 indicating severeness of the dirt such as dust on the filter 101, based on the filter image 71 registered in the cleaning service information 53. Specifically, the dirt severeness 533 is expressed by a method of quantifying stepwisely states from a state of no dust sticking to the filter 101 to a state of failing to ventilate because of the dust sticking to the filter 101.

For example, the image registration unit 310 registers the filter image 71 obtained by photographing the filter 101 provided with a character or a symbol. The dirt evaluation unit 330 determines the dirt severeness 533 based on an outcome of reading the character or the symbol included in the filter image 71.

Further, for example, the image registration unit 310 registers the filter image 71 obtained by photographing the filter 101 where specific solvent has been sprayed on dirt. The dirt evaluation unit 330 determines the dirt severeness 533 based on a state of the dirt sprayed with the solvent, included in the filter image 71.

Further, the dirt evaluation unit 330 determines the dirt severeness 533 based on a change of color of the dirt on the filter 101 included in the filter image 71.

Further, the dirt evaluation unit 330 may calculate correlation data between the lifestyle 52 of the user and the dirt severeness 533, and set the correlation data in the cleaning service information 53.

The dirt evaluation unit 330 transmits to the maintenance terminal apparatus 390, the lifestyle information 50 in which information such as the dirt severeness 533 or the correlation data has been registered. The maintenance terminal apparatus 390 visualizes the information such as the dirt severeness 533 or the correlation data, and displays the information on the display equipment 941. The maintenance person 32 presents the consumable item 40 or the service to be recommended to the user of the air conditioning machine 100, using the information such as the visualized dirt severeness 533 or the visualized correlation data.

***Other Configurations***

In the present embodiment, the function of each apparatus in the maintenance management system 500 is realized by the software. As a modification example, the function of each apparatus in the maintenance management system 500 may be realized by the hardware.

Specifically, each apparatus in the maintenance management system 500 includes an electronic circuit 909 instead of the processor 910.

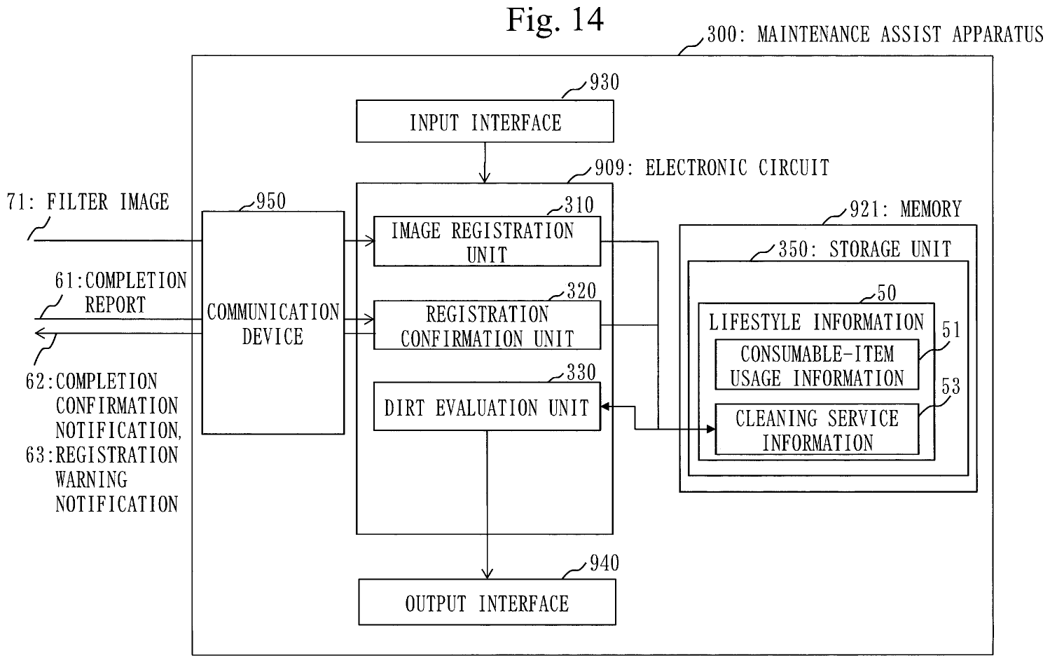

FIG. 14 is a diagram illustrating a configuration of the maintenance assist apparatus 300 according to a modification example of the present embodiment. IIere, a modification example of the maintenance assist apparatus 300 is taken as an example. However, each of the other apparatuses which are the air conditioning machine 100, the management apparatus 200, the control equipment 190, and the maintenance terminal apparatus 390 includes the electronic circuit 909 instead of the processor 910 similarly.

The electronic circuit 909 is a dedicated electronic circuit which realizes the function of each apparatus in the maintenance management system 500. The electronic circuit 909 is specifically a single circuit, a composite circuit, a programmed processor, a parallel-programmed processor, a logic IC, a GA, an ASIC, or an FPGA. GA stands for Gate Array. ASIC stands for Application Specific Integrated Circuit. FPGA stands for Field-Programmable Gate Array.

The function of each apparatus in the maintenance management system 500 may be realized by one electronic circuit or may be realized by distributing the function over a plurality of electronic circuits.

As another modification example, a part of the function of each apparatus in the maintenance management system 500 may be realized by the electronic circuit, and the rest of the function may be realized by the software. Alternatively, a part or all of the function of each apparatus in the maintenance management system 500 may be realized by firmware.

Each of the processor and the electronic circuit is referred to as processing circuitry. That is, the function of each apparatus in the maintenance management system 500 is realized by the processing circuitry.

### Description of Effect of Present Embodiment

According to the maintenance management system according to the present embodiment, when the maintenance person transmits the completion report of the cleaning service, the maintenance assist apparatus determines whether or not the filter image has been registered. When the filter image has not been registered, the maintenance assist apparatus transmits the registration warning notification to the maintenance terminal apparatus. Therefore, it is possible to certainly register the filter image by the maintenance person, and certainly accumulate the filter images to be used for analysis on the dirt on the filter. Further, the filter images are certainly accumulated, as a result, it is possible to analyze the dirt on the filter highly accurately.

Further, according to the maintenance management system according to the present embodiment, it is possible to visualize the information such as the dirt severeness or the correlation data, and display the information on the display equipment of the maintenance terminal apparatus. Thereby, the maintenance person can use the visualized information and properly present the consumable item or the service to be recommended to the user of the air conditioning machine.

### Second Embodiment

In the present embodiment, matters different from the first embodiment and matters added to the first embodiment will be mainly described.

In the present embodiment, the same reference numerals are assigned to configurations having the same functions as those in the first embodiment, and descriptions will be omitted.

***Description of Configuration***

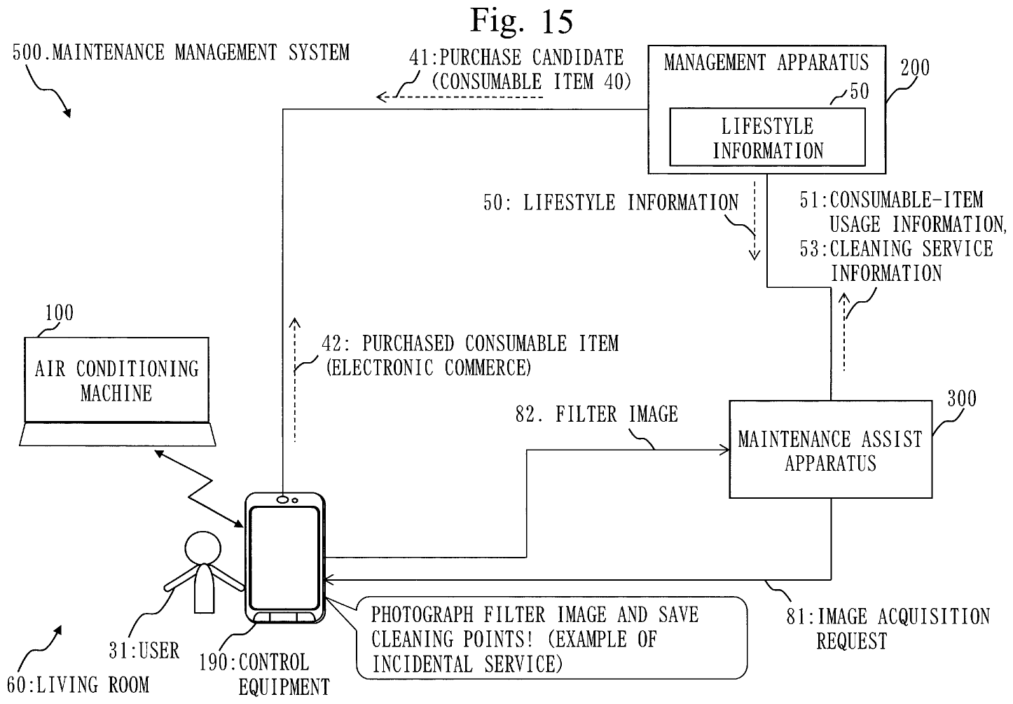

FIG. 15 is a diagram illustrating a configuration example of the maintenance management system 500 according to the present embodiment.

In the maintenance management system 500 according to the present embodiment, the maintenance assist apparatus 300 and the control equipment 190 communicate with each other via the network.

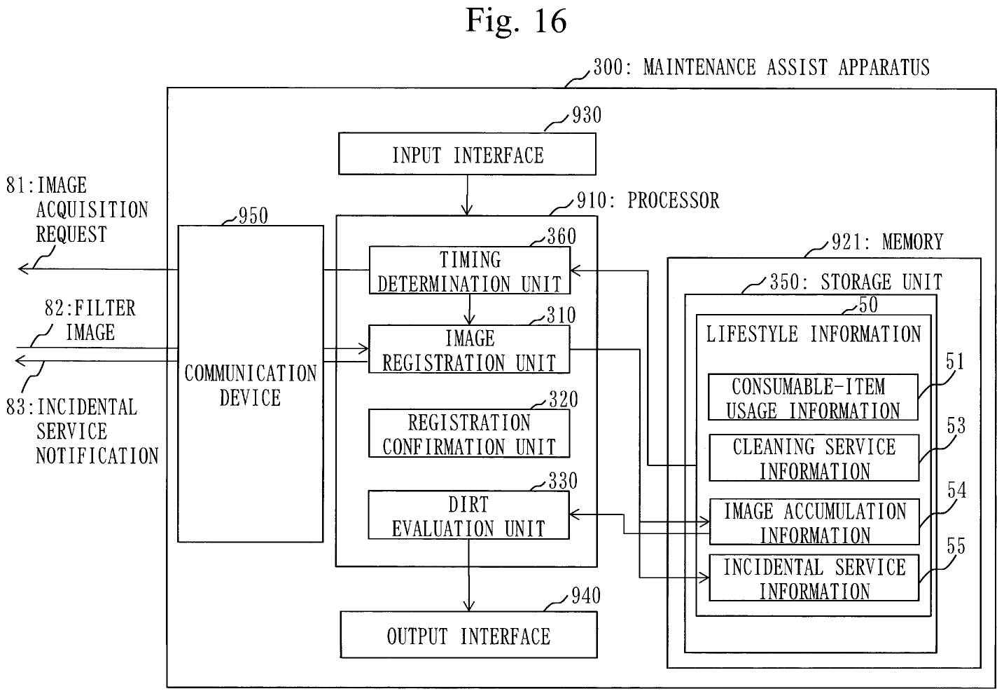

FIG. 16 is a diagram illustrating a configuration of the maintenance assist apparatus 300 according to the present embodiment.

The maintenance assist apparatus 300 according to the present embodiment includes a timing determination unit 360 in addition to the configuration in the first embodiment. Further, in addition to the configuration in the first embodiment, image accumulation information 54 and incidental service information 55 are set in the lifestyle information 50 in the storage unit 350.

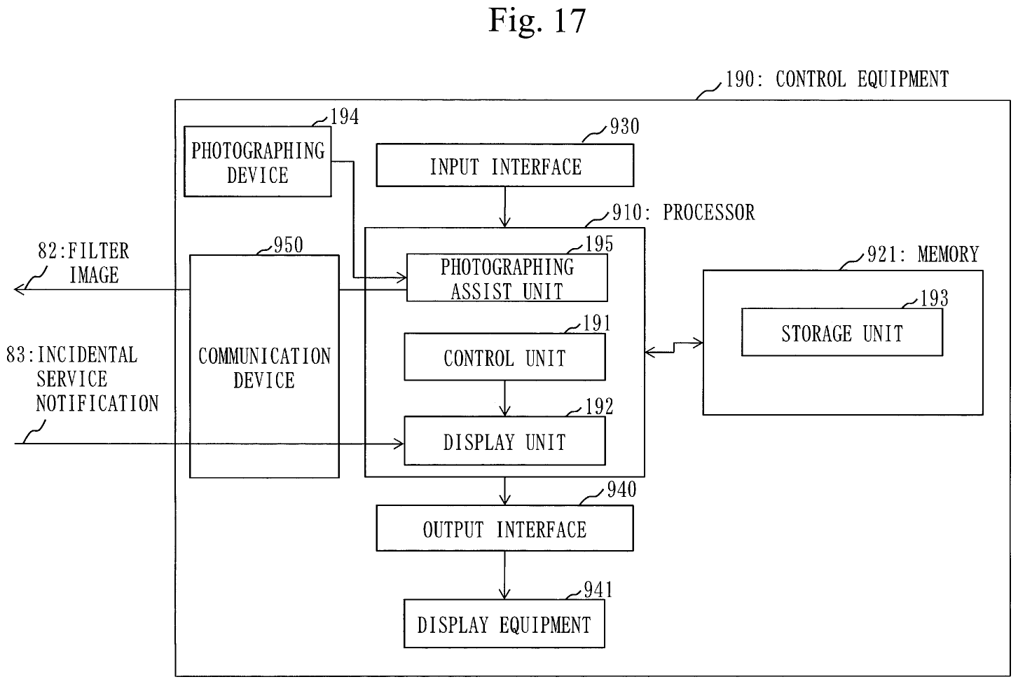

FIG. 17 is a diagram illustrating a configuration of the control equipment 190 according to the present embodiment.

The control equipment 190 according to the present embodiment includes a photographing assist unit 195 in addition to the configuration in the first embodiment. Further, the control equipment 190 according to the present embodiment includes a photographing device 194. Here, functions of the photographing device 194 and the photographing assist unit 195 are similar to the functions of the photographing device 394 and the photographing assist unit 395 of the maintenance terminal apparatus 390 described in the first embodiment.

***Description of Operation***

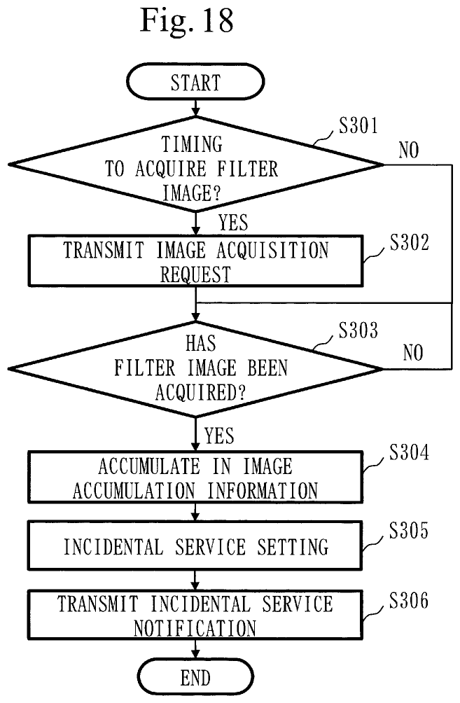

FIG. 18 is a flow diagram illustrating an operation example of the maintenance assist apparatus 300 according to the present embodiment.

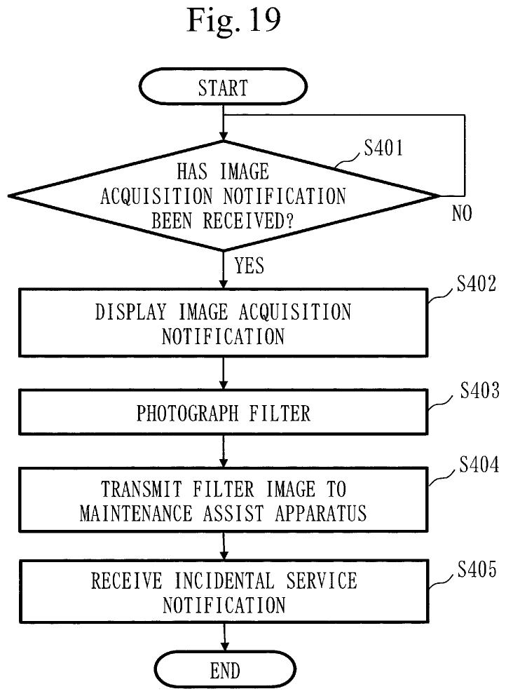

FIG. 19 is a flow diagram illustrating an operation example of the control equipment 190 according to the present embodiment.

With use of FIGS. 18 and 19, an operation of the maintenance management system 500 according to the present embodiment will be described.

An operation procedure of the maintenance management system 500 is equivalent to the maintenance management method. Further, a program which realizes the operations of the maintenance management system 500 is equivalent to the maintenance management program.

In step S301, the timing determination unit 360 of the maintenance assist apparatus 300 determines whether or not it is a timing to acquire the filter image obtained by photographing the filter of the air conditioning machine 100. The timing determination unit 360 determines whether or not it is the timing to acquire the filter image, based on the cleaning service information 53 and the lifestyle 52 of the user.

When the timing determination unit 360 determines that it is the timing to acquire the filter image, the process proceeds to step S302. When the timing determination unit 360 determines that it is not the timing to acquire the filter image, the process proceeds to step S303.

In step S302, the timing determination unit 360 transmits to the control equipment 190, an image acquisition request 81 which requests acquisition of the filter image.

For example, the air conditioning machine 100 is connected to another apparatus in the maintenance management system 500 via the Internet. The management apparatus 200 continuously monitors the lifestyle which is lifecycle data of the user 31, and operation time of the air conditioning machine 100. The timing determination unit 360 transmits the image acquisition request 81 as an alert, to the control equipment 190 of the user 31, based on this life cycle data and this operation time.

Note that, the timing determination unit 360 may transmit the image acquisition request 81 to either or both of the control equipment 190 of the user 31 or/and a portable terminal such as a smartphone, which has been registered by the user 31 in advance.

Further, the timing determination unit 360 may determine the timing to acquire the filter image, based only on the operation time of the air conditioning machine 100. Alternatively, the timing determination unit 360 may determine the timing to acquire the filter image, taking the lifestyle of the user 31 into consideration in addition to the operation time of the air conditioning machine 100. Specifically, if the user 31 lives in an area where a lot of pollen spreads, the timing determination unit 360 may shorten an interval between the acquisitions of the filter images and determine the timing to acquire the filter image in a season when a lot of pollen spreads.

In step S401, the photographing assist unit 195 of the control equipment 190 determines whether or not the image acquisition request 81 has been received from the maintenance assist apparatus 300. If the image acquisition request 81 has been received, the process proceeds to step S402.

In step S402, the photographing assist unit 195 displays the image acquisition request 81 on the display equipment 941. The image acquisition request 81 displayed on the display equipment 941 enables the user 31 to recognize that it is the timing to photograph the filter of the air conditioning machine and transmit it.

In step S403, the photographing assist unit 195 assists the user 31 in photographing the filter. Here, a photographing assist process for the user 31 by the photographing assist unit 195 is similar to a photographing assist process for the maintenance person 32 by the photographing assist unit 395 of the maintenance terminal apparatus 390, described in the first embodiment.

In step S404, the photographing assist unit 195 transmits to the maintenance assist apparatus 300, a filter image 82 which the photographing device 194 has photographed by the control of the user 31.

In step S303, when the image registration unit 310 of the maintenance assist apparatus 300 acquires the filter image 82 from the control equipment 190, the process proceeds to step S304.

In step S304, the image registration unit 310 accumulates in the storage unit 350, the filter images 82 photographed by the user 31. Specifically, the image registration unit 310 accumulates the filter images 82 in the image accumulation information 54 of the lifestyle information 50.

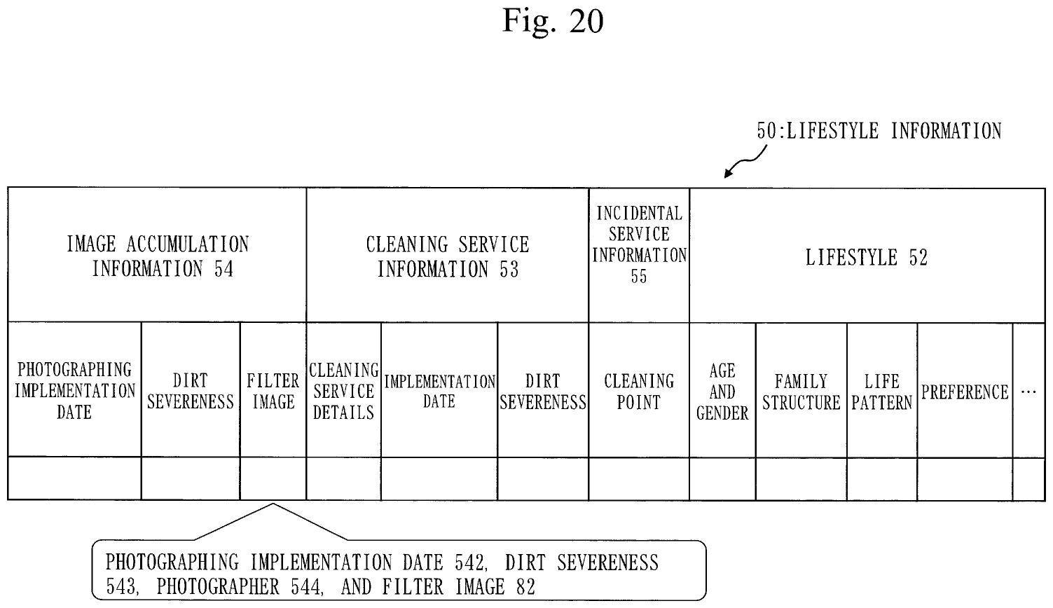

FIG. 20 is a diagram illustrating a configuration example of the lifestyle information 50 according to the present embodiment.

The lifestyle information 50 according to the present embodiment includes: the image accumulation information 54 accumulating the filter images; the cleaning service information 53 where the usage status of the cleaning service on the air conditioning machine 100 is set; and the lifestyle 52 of the user. Additionally, information such as the consumable-item usage information 51 described in the first embodiment may be included.

Further, the lifestyle information 50 according to the present embodiment includes the incidental service information 55 for offering an incidental service as an expression of gratitude to the user 31 for photographing the filter image 82 and transmitting the filter image 82 to the maintenance assist apparatus 300.

For example, in the image accumulation information 54, pieces of information such as photographing implementation date 542, dirt severeness 543, a photographer 544, and the filter image 82 are set.

In step S305, the image registration unit 310 sets as the incidental service information 55, information for offering the incidental service to the user 31.

In step S306, the image registration unit 310 transmits an incidental service notification 83 which notifies the user 31 that the incidental service has been offered. The image registration unit 310 may transmit the incidental service notification 83 to the control equipment 190 or to the portable terminal such as a smartphone, which has been registered by the user 31 in advance.

In step S405, when the display unit 192 of the control equipment 190 receives the incidental service notification 83 from the maintenance assist apparatus 300, the display unit 192 displays the incidental service notification 83 on the display equipment 941.

Note that, the incidental service is specifically such a discount as below.
A free cleaning service ticket issued when a filter image is transmitted certain times (for example, twice) a year
10% off on a purchase price of an air conditioning machine next time when a filter image is transmitted

Alternatively, the incidental service can be any type of service as long as the user 31 can receive a beneficial service as an expression of compensation or gratitude for photographing and transmitting the filter image.

The dirt evaluation unit 330 according to the present embodiment determines the dirt severeness 543 on the filters based on the filter image 82 accumulated in the storage unit 350, and registers the dirt severeness 543 in the storage unit 350. Specifically, the dirt evaluation unit 330 determines the dirt severeness 543 on the filters based on the filter image 82 accumulated in the image accumulation information 54. A dirt evaluation process by the dirt evaluation unit 330 is similar to that in the first embodiment. However, in the present embodiment, since the photographer is the user 31, the dirt evaluation using the solvent is not implemented.

### Description of Effect of Present Embodiment

According to the maintenance management system of to the present embodiment, by having the user photograph the filter image, it is possible to acquire the filter image in real time, at a timing selected based on the lifecycle, that is the timing required by the maker. Therefore, the maker can obtain data on the dust and dirt on the filter according to a market environment by acquiring the filter image at a proper timing according to the lifestyle of the user and operation status.

Further, the filter images are acquired globally from fixed users in different locations a plurality of times. Thereby, it is possible to clarify differences among the locations globally and develop products according to individual environments of the locations in a global market.

Further, according to the maintenance management system of the present embodiment, it is possible to retain customers by realizing a system from which the customers can receive an incidental service based on the number of times that the customer has transmitted the filter image.

In a scheme of the first embodiment, the maintenance person can photograph the filter only when the customer requires the cleaning service for the filter, that is only when the filter thoroughly becomes dirty. However, the maker also desires to acquire the filter images in transition before the filter becomes dirty, for a purpose of analysis on the dirt on the filter. According to the maintenance management system, it is possible to acquire the filter images in transition before the filter becomes dirty, with a support from the customer in photographing the filter. Further, it is possible to further improve a success rate in acquiring the filter image by the user, since the customer can receive the incidental service only by photographing and transmitting the filter images.

In the first embodiment and the second embodiment above, each unit of each apparatus in the maintenance management system 500 has been described as an independent function block. However, the configuration of each apparatus in the maintenance management system 500 does not need to be a configuration as in the embodiments described above. The function blocks of each apparatus in the maintenance management system 500 may be of any configurations as long as these can realize the functions described in the embodiments described above. Further, each apparatus in the maintenance management system 500 may be a system composed of a plurality of apparatuses instead of a single apparatus.

Further, a plurality of portions in the first embodiment and the second embodiment may be combined and implemented. Alternatively, one portion of these embodiments may be implemented. Additionally, these embodiments may be combined in any manner, as a whole or partially, and implemented.

That is, in the first embodiment and the second embodiment, the individual embodiments may be combined in any manner, an arbitrary component in the individual embodiment may be modified, or an arbitrary component in the individual embodiment may be omitted.

Note that, the above-described embodiments are essentially preferred exemplifications and are not intended to limit a scope of the present disclosure, a scope of its applied product in the present disclosure, and a scope of usage in the present disclosure. Various types of modifications can be made to the embodiments described above, as necessary.

### REFERENCE SIGNS LIST

31: user, 32: maintenance person, 40: consumable item, 42: purchased consumable item, 50: lifestyle information, 51: consumable-item usage information, 52: lifestyle, 53: cleaning service information, 531: cleaning service details, 532: implementation date, 533, 543: dirt severeness, 534: implementation person, 54: image accumulation information, 542: photographing implementation date, 544: photographer, 55: incidental service information, 60: living room, 61: completion report, 62: completion confirmation notification, 63: registration warning notification, 71, 82: filter image, 81: image acquisition request, 83: incidental service notification, 100: air conditioning machine, 101: filter, 102: filter frame, 103: specific mark, 104: corner part, 110: information reception unit, 120: information transmission unit, 130, 191, 391: control unit, 190: control equipment, 192, 392: display unit, 200: management apparatus, 210: candidate display unit, 220: selection reception unit, 230: purchase assist unit, 240: information setting unit, 193, 140, 250, 350, 393: storage unit, 260: cleaning-liquid determination unit, 300: maintenance assist apparatus, 310: image registration unit, 320: registration confirmation unit, 330: dirt evaluation unit, 360: timing determination unit, 390: maintenance terminal apparatus, 391: control unit, 392: display unit, 393: storage unit, 194, 394: photographing device, 195, 395: photographing assist unit, 301: refrigerant circuit, 302: compressor, 33: four-way valve, 34: first heat exchanger, 35: expansion mechanism, 36: second heat exchanger, 37: controller, 500: maintenance management system, 909: electronic circuit, 910: processor, 921: memory, 930: input interface, 940: output interface, 941: display equipment, 950: communication device.

1. A maintenance management system which manages maintenance of an air conditioning machine, comprising:
a maintenance assist apparatus which assists with the maintenance of the air conditioning machine; and
a maintenance terminal apparatus carried by a maintenance person who implements a cleaning service on the air conditioning machine, wherein
the maintenance assist apparatus comprises:
processing circuitry
to register in cleaning service information where usage status of the cleaning service on the air conditioning machine is set, a dirt image indicating dirt severeness obtained by the maintenance person photographing a filter of the air conditioning machine; and
to determine whether or not the dirt image has been registered in the cleaning service information, when a completion report which reports completion of the cleaning service is acquired from the maintenance terminal apparatus, output to the maintenance terminal apparatus, a completion confirmation notification which notifies that the completion of the cleaning service has been confirmed, when it is determined that the dirt image has been registered, and output to the maintenance terminal apparatus, a registration warning notification which prompts registration of the dirt image, when it is determined that the dirt image has not been registered.

2. The maintenance management system according to claim 13, the maintenance terminal apparatus comprising
the processing circuitry to facilitate photographing the filter by enabling a filter frame included in the filter to be positioned at a specific mark, thereby assisting in photographing the filter.

3. The maintenance management system according to claim 2, wherein
the processing circuitry facilitates photographing the filter by enabling a corner part of the filter frame included in the filter to be positioned at the specific mark.

4. The maintenance management system according to claim 13, wherein
the processing circuitry determines the dirt severeness of the filter based on the filter image registered in the cleaning service information, and registers the dirt severeness in the cleaning service information.

5. The maintenance management system according to claim 4, wherein
the processing circuitry
registers the filter image obtained by photographing the filter provided with a character or a symbol, and
determines the dirt severeness based on an outcome of reading the character or the symbol included in the filter image.

6. The maintenance management system according to claim 4, wherein
the processing circuitry
registers the filter image obtained by photographing the filter where specific solvent has been sprayed on dirt, and
determines the dirt severeness based on a state of the dirt after the solvent having been sprayed, included in the filter image.

7. The maintenance management system according to claim 4, wherein
the processing circuitry determines the dirt severeness based on a change of color of the dirt on the filter included in the filter image.

8. The maintenance management system according to claim 4, wherein
the cleaning service information is included in lifestyle information indicating a lifestyle of a user who uses the air conditioning machine, and
the processing circuitry calculates correlation data between the lifestyle of the user and the dirt severeness.

9. The maintenance management system according to claim 4, wherein
the filter image includes an image of a filter before the cleaning service is implemented, and an image of a filter after the cleaning service is implemented.

10. A maintenance assist apparatus which communicates with a maintenance terminal apparatus carried by a maintenance person who implements a cleaning service on an air conditioning machine, and which assists with maintenance of the air conditioning machine, comprising:
processing circuitry
to register in cleaning service information where usage status of the cleaning service on the air conditioning machine is set, a dirt image indicating dirt severeness of the air conditioning machine; and
to determine whether or not the dirt image has been registered in the cleaning service information, when a completion report which reports completion of the cleaning service is acquired from the maintenance terminal apparatus, output a completion confirmation notification which notifies that the completion of the cleaning service has been confirmed, when it is determined that the dirt image has been registered, and output a registration warning notification which prompts registration of the dirt image, when it is determined that the dirt image has not been registered.

11. A maintenance management method used for a maintenance management system which manages maintenance of an air conditioning machine and comprises:
a maintenance assist apparatus which assists with the maintenance of the air conditioning machine; and
a maintenance terminal apparatus carried by a maintenance person who implements a cleaning service on the air conditioning machine, the maintenance management method comprising:
registering in cleaning service information where usage status of the cleaning service on the air conditioning machine is set, a dirt image indicating dirt severeness of the air conditioning machine; and
determining whether or not the dirt image has been registered in the cleaning service information, when a completion report which reports completion of the cleaning service is acquired from the maintenance terminal apparatus, outputting to the maintenance terminal apparatus, a completion confirmation notification which notifies that the completion of the cleaning service has been confirmed, when it is determined that the dirt image has been registered, and outputting to the maintenance terminal apparatus, a registration warning notification which prompts registration of the dirt image, when it is determined that the dirt image has not been registered.

12. (canceled)

13. The maintenance management system according to claim 1, wherein
the dirt image is a filter image obtained by photographing a filter of the air conditioning machine.
